(19) United States
(12) Patent Application Publication
(10) Pub. No.: US 2016/0292462 A1
(43) Pub. Date: Oct. 6, 2016

(54) POLICY-DRIVEN DEVICE CONTROL IN OPERATING SYSTEMS

(71) Applicant: Symantec Corporation, Mountain View, CA (US)

(72) Inventor: Anand SANKRUTHI, Chennai (IN)

(21) Appl. No.: 14/725,843

(22) Filed: May 29, 2015

(30) Foreign Application Priority Data
Mar. 31, 2015 (IN) 1708/CHE/2015

(51) Int. Cl. G06F 21/85

(52) U.S. Cl. CPC G06F 21/85

(57) ABSTRACT

Techniques describe a policy-driven approach to controlling device access. A dummy driver is mapped to the device. The dummy driver receives a request by an operating system to access services provided by the device. The dummy driver determines, based on a policy, whether to block access to the device. If so, the dummy driver prevents services from being accessed via the operating system.

### CROSS-REFERENCE TO RELATED APPLICATION

This application claims benefit of Indian Provisional Patent Application Serial No. 1708/CHE/2015 filed Mar. 31, 2015, which is incorporated herein by reference in its entirety.

### BACKGROUND

1. Field

Embodiments presented herein generally relate to device arbitration, and more specifically, to techniques for controlling access to attachable devices in an operating system.

2. Description of the Related Art

An operating system (OS) manages hardware and software resources for a computer system. For instance, the OS allows applications to access computer hardware, such as a processor, memory, and disks, in a uniform and controlled manner. Further, the OS includes drivers that control access by the applications to hardware devices (e.g., storage devices, Bluetooth devices, audio devices, etc.), which can be connected to and disconnected from the computer. For example, a user may want to connect a USB storage device to a computer system. A corresponding driver understands the low-level hardware details of that storage device, allowing it to communicate with the device.

An administrator may want to control devices that can be connected to a computer system, e.g., to prevent data leakage from users connecting a USB storage device to and extracting sensitive data from the system. Many operating systems provide a device control manager that a data loss protection (DLP) agent may integrate with. Once integrated, an administrator may manage devices that may be connected to a computer system. The administrator can configure which devices to allow access to or block access from the system. In turn, the device control manager, through the DLP agent, monitors access requests by the OS to connected devices.

However, some operating systems do not provide a device control manager that can be integrated with a DLP agent. As a result, blocking access to a device is difficult. For instance, Mac OS X, an Apple-based OS, does not generally provide a device control manager. Although approaches for controlling device access exist, they are limited to controlling access to the computer system by a storage device through a disk application API. This approach does not allow an administrator to block access to non-storage devices, such as cameras, Bluetooth devices, and the like. As a result, data leakage may possibly occur through such devices.

### SUMMARY

One embodiment presented herein describes a method for controlling access by an operating system to a device connected with a computer system based on a policy. The method generally includes mapping a dummy driver to the device. The method also includes receiving, by the dummy driver, a request by the operating system to access services provided by the device. The method also includes determining, based on the policy, whether to block access to the device. Upon determining to block access to the device, services are prevented from being accessed via the operating system.

Other embodiments include, without limitation, a computer-readable medium that includes instructions that enable a processing unit to implement one or more aspects of the disclosed methods as well as a system having a processor, memory, and application programs configured to implement one or more aspects of the disclosed methods.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, may admit to other equally effective embodiments.

FIG. 1 illustrates an example computing environment, according to one embodiment.

FIG. 2 further illustrates the dummy driver described relative to FIG. 1, according to one embodiment.

FIG. 3 illustrates a method for attaching a dummy driver to a device connected to a computing system, according, to one embodiment.

FIG. 4 illustrates a method for managing a request for access to a device, according to one embodiment.

FIGS. 5A and 5B illustrate an example device registry interface displaying properties of a device attached to a computing system, according to one embodiment.

FIG. 6 illustrates an example computing system configured to control device access, according to one embodiment.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Embodiments presented herein describe techniques for controlling device access to a computing system having an operating system that does not include a device manager.

A device driver controls access between an application and a device. Typically, when a device is attached to the computing system, the OS identifies drivers having a provider class corresponding to a bus to which the device is attached (e.g., USB, PCI, Firewire, Thunderbolt, etc.). The OS then identifies drivers which have properties matching the device. Examples of properties include such as vendor ID, max read timeout, max write rate, and the like. The OS then requests each identified driver to temporarily probe the device and generate a score based on the probe. A high score indicates a strength of the driver in communicating with the device, e.g., a confidence of how suitable the driver is for the device. The OS ranks the drivers by probe score and maps the driver having the highest score to the device.

In one embodiment, a data loss prevention (DLP) agent installs a dummy driver on the computing system. The dummy driver is configured such that the OS maps the dummy driver to any specified device when attached to the system. That is, the dummy driver specifies that it can support all provider classes of specified devices (e.g., USB, PCI, Firewire, Thunderbolt, etc.). In addition, the dummy driver specifies properties that match to all specified devices. Further, the dummy driver is configured to generate and return a high probe score to the OS. As a result, the OS maps the dummy driver to a specified device when the device is attached to the system.

In one embodiment, the dummy driver determines whether to allow or block device services based on a device arbitration policy (e.g., set by an administrator). For example, a policy may specify that the OS should not access services provided by a USB storage device. When a user attaches a device to the system, the OS maps the dummy driver to the device. The dummy driver determines, based on the policy, that the device should be blocked. The dummy driver may then return null to the OS. Doing so effectively prevents services provided by the device from being accessed. As a result, the user would not be able to access the device via the system. Further, the DLP agent may also report incidents of unauthorized connections to an administrator. If the dummy driver determines, based on the policy, to allow the device, the dummy driver provides access to the device through a system device framework.

Advantageously, the DLP agent uses the dummy driver to control access to specified devices in an OS that does not otherwise provide a device control manager that can be integrated with DLP services. Further, the dummy driver determines which of the devices to allow or block based on a device arbitration policy. As a result, the DLP agent may generate incident reports for instances where a user attaches a device specified as blocked in the policy.

Note, the following describes installing a dummy driver on a BSD UNIX-based operating system (or derivative thereof, e.g., Mac OS X) as an example of controlling device access on a computing system. However, one of ordinary skill in the art will recognize that techniques described herein may be adapted to other operating systems that allow custom device drivers to connect with a specified device. In such a case, the dummy driver is configured such that the operating system always maps the driver to the specified device, e.g., by generating a high probe or priority score. Once mapped, the dummy driver may then determine whether to allow or block access to the device based on a device arbitration policy.

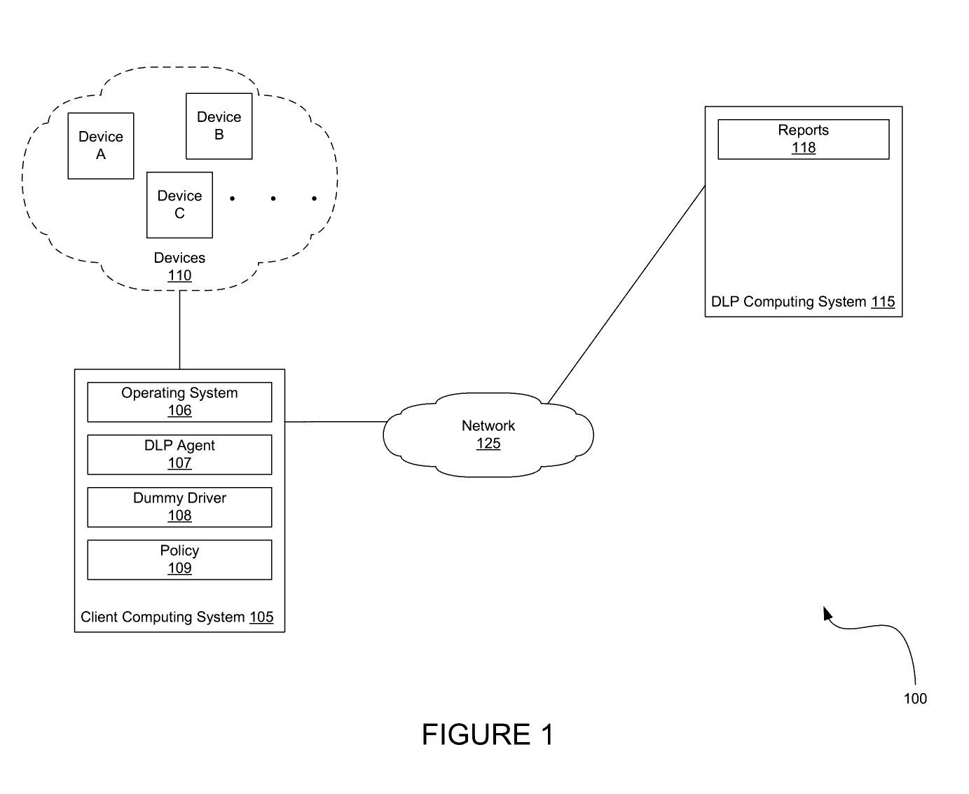

FIG. 1 illustrates an example computing environment 100, according to one embodiment. As shown, the computing environment 100 includes a client computing system 105, one or more devices 110, a data loss prevention (DLP) computing system 115, and a network 125. In one embodiment, the client computing system 105 is a physical computing system that executes a BSD UNIX-based operating system or derivative thereof, e.g., Mac OS X. Further, the client computing system 105 may one system out of many in an enterprise network.

In one embodiment, the client computing system 105 includes an operating system (OS) 106, a DLP agent 107, a dummy driver 108, and a policy 109. The OS 106 manages hardware and software resources for a computer system. For instance, the OS 106 allows applications to access computer hardware, such as a processor, memory, and disks, in a uniform and controlled manner. The DLP agent 107 installs the dummy driver 108 on the OS 106. The dummy driver 106 may be maintained in a device driver library of the OS 106. The OS maps the dummy driver 106 to known devices 110 when attached to the client computing system 105.

As described further below, the dummy driver 108 includes a configuration specifying devices 110 and properties of those devices. Such configuration allows the dummy driver 108 to be selected by the OS 106 for mapping to a given device 110. Properties may include provider interface classes of devices 110, such as USB, FireWire, Thunderbolt, and the like. Further, the properties may also include identifiers, timeout properties, I/O rate, etc., associated with the device. The dummy driver 108 further generates a probe score that the OS 106 ranks higher in priority than other competing drivers compatible with the device 110. The probe score is discussed in further detail below. As a result of the probe score, the OS 106 selects and maps the dummy driver 108 to a given device 110 when the device 110 is attached to the client computing system 105.

In one embodiment, the policy 109 specifies which of the devices 110 should be blocked from access. For example, the policy 109 may specify that all USB storage devices should not be accessed by the OS 106. When the dummy driver 108 is connected to a given device 110, the dummy driver 108 determines whether to block or allow access to the device 110 based on the policy 109. If the policy 109 specifies to block the device 110, then the dummy driver 108 returns null to the OS 106, effectively providing no device services to the OS 106. If allowed, the dummy driver 108 provides access to device services through a system device framework.

In one embodiment, the DLP agent 107 may generate incident reports when an unauthorized device is attached to the client computing system 105. The DLP agent 107 may send the reports to the DLP computing system 115 over the network 125. The DLP computing system 115 may store the reports (as reports 118) for later review by an administrator.

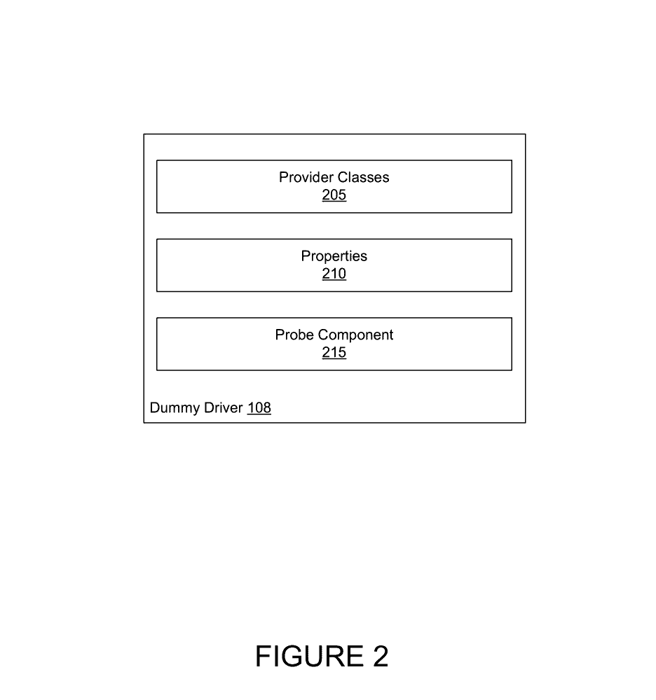

FIG. 2 further illustrates the dummy driver 108, according to one embodiment. As shown, the dummy driver 108 includes provider classes 205, properties 210, and a probe component 215.

In one embodiment, the provider classes 205 specify bus interfaces of the devices 110 to be covered by the dummy driver 108. For example, the provider classes 205 specify various interfaces, such as USB, PCI, Thunderbolt, FireWire, and so on. Typically, when the OS 106 detects an attached device 110, the OS 106 identifies drivers in a driver library that have a provider class that matches that of the attached device 110. The OS 106 can identify the dummy driver 108 as having a matching provider class for a given device 110 based on the provider classes 205.

In one embodiment, the properties 210 specify attributes for the devices 110 to be covered by the dummy driver 108. For example, such properties 210 include vendor IDs, physical interconnect type, physical interconnect location, read/write time out durations, interface classes and subclasses, and the like. When the OS 106 detects an attached device 110, the OS 106 identifies drivers in the driver library having matching properties to the device 110.

In one embodiment, the probe component 215 temporarily connects the driver to an attached device 110 and generates a high probe score. As known, when a device driver probes a given device, the device driver evaluates features of the device and determines a strength of connection between the driver and the device. Based on such evaluation, the device driver generates a probe score. In turn, the OS 106 ranks competing device drivers by probe score. Further, the OS 106 selects the driver having the highest probe score for mapping to the device. In one embodiment, the probe component 215 generates a high probe score regardless of strength of communication with the device. Generally, the probe score generated by the probe component 215 should be high enough to outrank competing device drivers. What entails such a probe score may differ between devices.

Once mapped to the device, the dummy driver 108 determines whether to grant access to the device by the OS 106 based on a device arbitration policy. If the policy specifies the device should be blocked, then the dummy driver 108 returns null to the OS 106 whenever the OS 106 requests access to the device. As a result, the OS 106 is unable to access services provided by the device. Otherwise, the dummy driver 108 allows the OS 106 to access to the device via a system device framework which is provided by the OS 106. The dummy driver 108 serves as a primary driver for the device and provides services to the device through the framework.

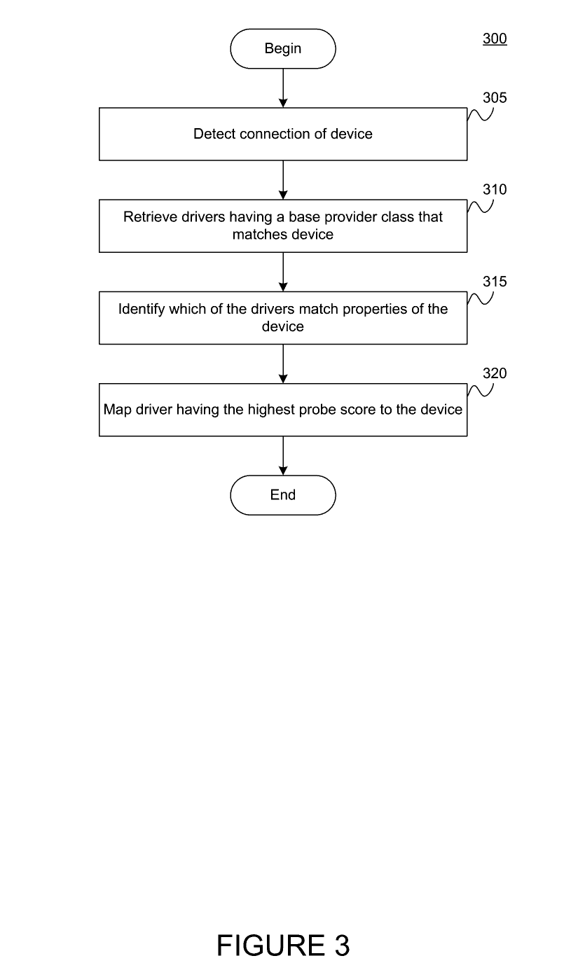

FIG. 3 illustrates a method 300 for attaching a dummy driver to a device connected to a computing system, according, to one embodiment. As shown, method 300 begins at step 305, where the OS 106 detects that a device has been attached. As an example, assume that the device is specified in a configuration of the dummy driver 108. That is, the configuration of the dummy driver 108 specifies the provider class and properties of the device. Further, the dummy driver 108 can also generate a probe score that is higher than competing device drivers.

At step 310, the OS 106 retrieves drivers that have a base provider class that matches that device. For instance, if the device is connected to the computing system via USB, then the OS 106 retrieves drivers that specify a provider class that corresponds to the USB interface. In this example, the OS 106 retrieves the dummy driver 108 as one of the drivers having a base provider that matches the device.

At step 315, the OS 106 identifies which of the drivers match properties of the device. As stated, properties may include a vendor ID, max timeout, write/read speed, and the like that are associated with the device. In this example, because the device is specified in the configuration of the dummy driver 108, the dummy driver 108 includes the matching properties. As a result, the OS 106 identifies the dummy driver 108 as one of the drivers that matches properties of the device.

At step 320, the OS 106 maps the driver having the highest probe score to the device. Generally, to determine which of the identified drivers has the highest probe score, the OS 106 allows temporary access to the device by each driver. Each driver probes various features of the driver to determine how strongly the driver communicates with the device. The dummy driver 108 generate a probe score that is higher than the probe score generated by other drivers. As a result, the OS 106 maps the dummy driver 108 to the device.

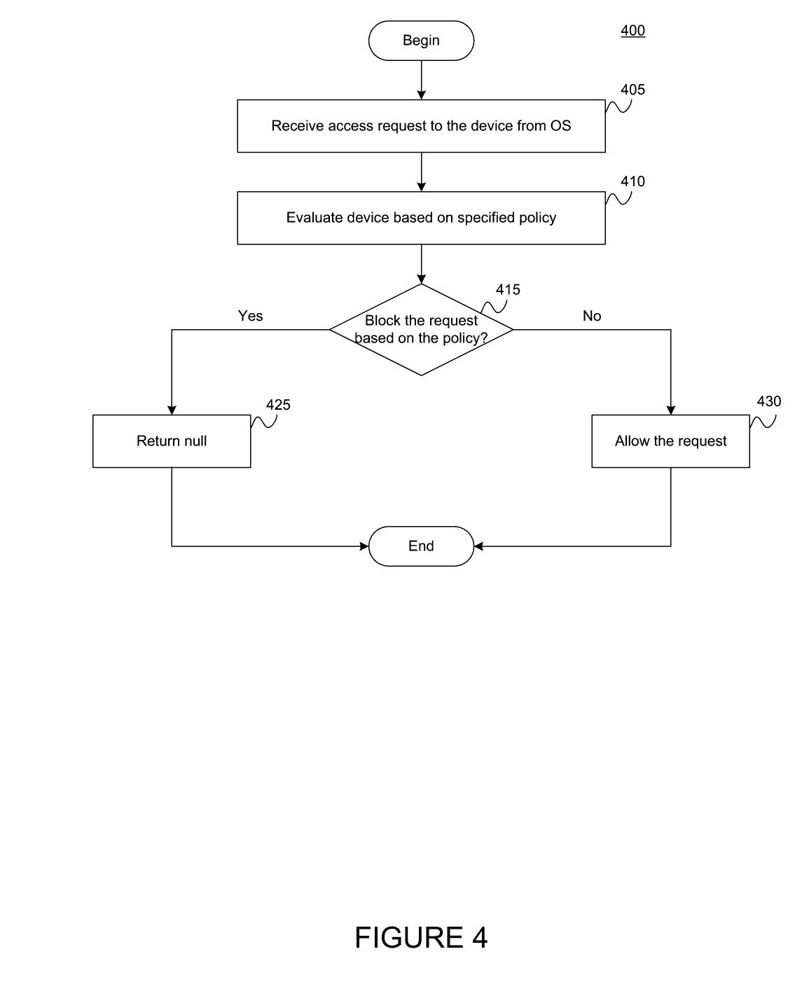

FIG. 4 illustrates a method 400 for managing a request for access to a device, according to one embodiment. Assume that the OS 106 has mapped the dummy driver 108 to the device. As shown, method 405 beings at step 405, where the dummy driver 108 receives an access request to the device from the OS 106. At step 410, the dummy driver 108 evaluates the device based on a device arbitration policy. For instance, the dummy driver 108 determines characteristics of the device, such as type of device, manufacturer of the device, bus interface, etc. At step 415, the dummy driver 108 then determines whether the policy specifies that a device having such characteristics should be allowed or blocked.

If so, then at step 425, the dummy driver 108 returns null to the OS 106. That is, the dummy driver 108 provides no devices services for the OS 106 to access. Otherwise, then at step 430, the dummy driver 108 allows the request. To do so, the dummy driver 108 may provide access to device services via the system device framework provided by the OS 106.

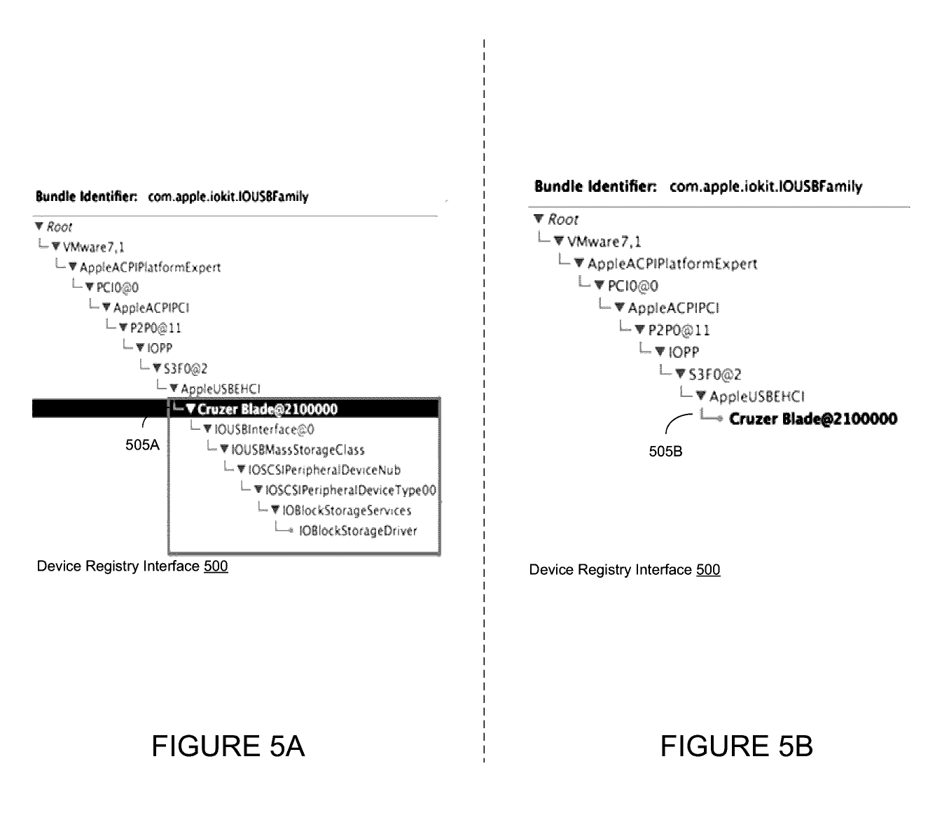

FIGS. 5A and 5B illustrate an example device registry interface 500 displaying properties of a device attached to a computing system, according to one embodiment. The interface 500 is of an application provided by the OS that allows a user to view information for devices connected to the computing system. The interface 500 displays a device name and services provided by the device. FIG. 5A depicts the interface 500 that displays information about a USB flash drive device that is attached to the computing system. In this example, the default driver is mapped to the USB flash drive device. Box 505A provides a name of the flash drive device (“Cruzer Blade@2100000”) as well as other information, such as the provider class (“IOUSBInterface@0”) and services provided by the device (“IOBlockStorageServices”).

FIG. 5B depicts the interface 500 that displays information about the USB flash drive device that is attached to the computing system. In this example, the dummy driver 108 is mapped to the USB flash drive device. Further, assume in this example that this particular USB flash drive device is specified as blocked according to a device arbitration policy. In contrast to box 505A, box 505B provides only the name of the flash drive device (“Cruzer Blade@2100000”). That is, because the dummy driver 108 is mapped to the USB flash drive device, the dummy driver 108 does not provide any access.

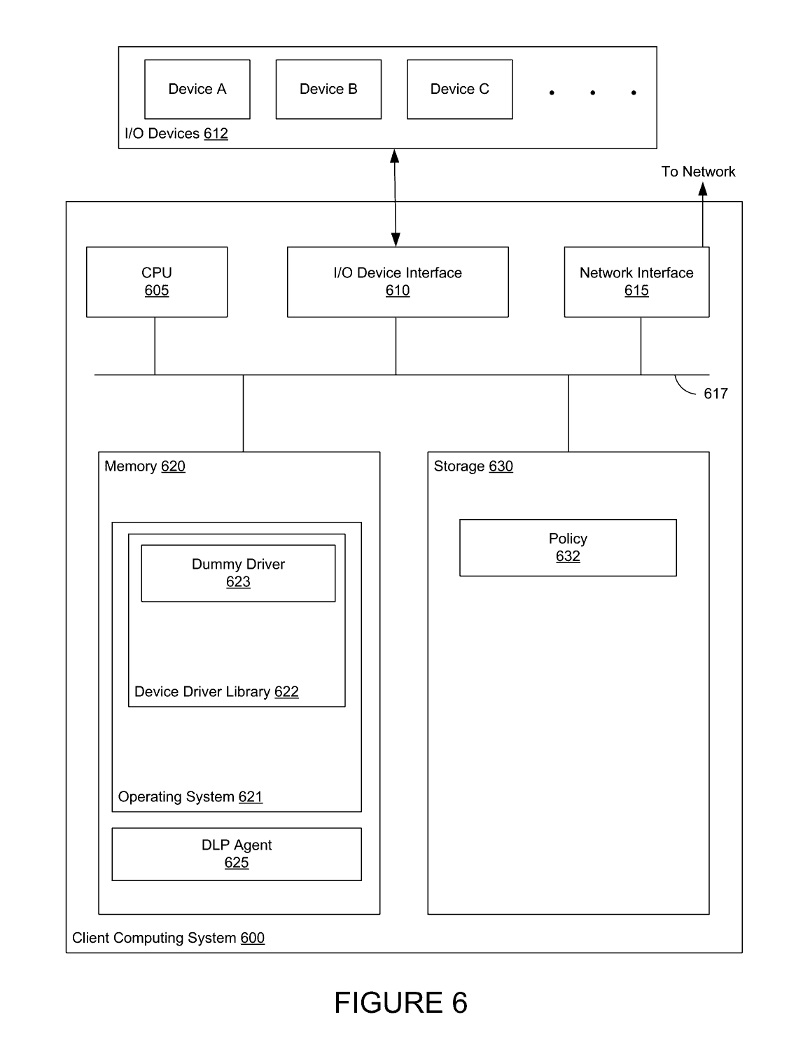

FIG. 6 illustrates an example computing system 600 configured to control device access, according to one embodiment. As shown, computing system 600 includes, without limitation, a central processing unit (CPU) 605, a network interface 615, a memory 620, and storage 630, each connected to a bus 617. The computing system 600 may also include an I/O device interface 610 connecting multiple I/O devices 612 (e.g., keyboard, display, mouse devices, external storage devices, Bluetooth devices, etc.) to the computing system 600. Further, in context of the present disclosure, the computing elements shown in the computing system 600 may correspond to a physical computing system (e.g., a system in an enterprise network).

CPU 605 retrieves and executes programming instructions stored in memory 620 as well as stores and retrieves application data residing in the storage 630. The bus 617 is used to transmit programming instructions and application data between CPU 605, I/O devices interface 610, storage 630, network interface 615, and memory 620. Note, CPU 605 is included to be representative of a single CPU, multiple CPUs, a single CPU having multiple processing cores, and the like. Memory 620 is generally included to be representative of a random access memory. Storage 630 may be a disk drive storage device. Although shown as a single unit, storage 630 may be a combination of fixed and/or removable storage devices, such as fixed disc drives, removable memory cards, or optical storage, network attached storage (NAS), or a storage area-network (SAN).

Illustratively, memory 620 includes an operating system (OS) 621 and a DLP agent 625. And storage 630 includes a policy 632. The OS 621 manages hardware and software resources for a computing system 600. The OS 621 further includes a device driver library 622 which maintains one or more device drivers. In particular, the device driver library 622 includes a dummy driver 623. The DLP agent 625 may install the dummy driver to the OS 621.

In one embodiment, the dummy driver 623 is configured such that the OS 621 automatically maps the driver 623 to specified devices 612. To do so, a configuration of the dummy driver 623 includes information describing such devices 612, such as provider class and properties. Further, the dummy driver 623 may generate a high probe score that results in the OS 621 prioritizing the driver 623 over other competing drivers when a given device 612 is attached to the computing system 600.

When mapped to a device 612, the dummy driver 623 may control access to that device based on the policy 632. If the policy 632 specifies that the device 612 should be blocked, the dummy driver 623 returns null in response to access requests from the OS 621. If the policy 632 specifies that access to the device 612 is allowed, then the dummy driver 623 allows access to the device 612 (e.g., by providing devices services through the system framework of the OS 621).

The preceding discussion presents a variety of embodiments. However, the present disclosure is not limited to the specifically described embodiments. Instead, any combination of the following features and elements, whether related to different embodiments or not, is contemplated to implement and practice the techniques described herein. Furthermore, although embodiments of the present disclosure may achieve advantages over other possible solutions and/or over the prior art, whether or not a particular advantage is achieved by a given embodiment is not limiting of the present disclosure. Thus, the following aspects, features, embodiments and advantages are merely illustrative and are not considered elements or limitations of the appended claims except where explicitly recited in a claim(s).

Aspects may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus or device.

The flowchart and block diagrams in the figures illustrate the architecture, functionality and operation of possible implementations of systems, methods and computer program products according to various embodiments presented herein. In this regard, each block in the flowchart or block diagrams may represent a module, segment or portion of code, which comprises one or more executable instructions for implementing the specified logical function(s). In some alternative implementations the functions noted in the block may occur out of the order noted in the figures. For example, two blocks shown in succession may, in fact, be executed substantially concurrently, or the blocks may sometimes be executed in the reverse order, depending upon the functionality involved. Each block of the block diagrams and/or flowchart illustrations, and combinations of blocks in the block diagrams and/or flowchart illustrations can be implemented by special-purpose hardware-based systems that perform the specified functions or acts, or combinations of special purpose hardware and computer instructions.

The following discussion presents a variety of embodiments. However, the present disclosure is not limited to the specifically described embodiments. Instead, any combination of the following features and elements, whether related to different embodiments or not, is contemplated to implement and practice the techniques described herein. Furthermore, although embodiments of the present disclosure may achieve advantages over other possible solutions and/or over the prior art, whether or not a particular advantage is achieved by a given embodiment is not limiting of the present disclosure. Thus, the following aspects, features, embodiments and advantages are merely illustrative and are not considered elements or limitations of the appended claims except where explicitly recited in a claim(s).

Aspects may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus or device.

The flowchart and block diagrams in the figures illustrate the architecture, functionality and operation of possible implementations of systems, methods and computer program products according to various embodiments presented herein. In this regard, each block in the flowchart or block diagrams may represent a module, segment or portion of code, which comprises one or more executable instructions for implementing the specified logical function(s). In some alternative implementations the functions noted in the block may occur out of the order noted in the figures. For example, two blocks shown in succession may, in fact, be executed substantially concurrently, or the blocks may sometimes be executed in the reverse order, depending upon the functionality involved. Each block of the block diagrams and/or flowchart illustrations, and combinations of blocks in the block diagrams and/or flowchart illustrations can be implemented by special-purpose hardware-based systems that perform the specified functions or acts, or combinations of special purpose hardware and computer instructions.

While the foregoing is directed to embodiments of the present disclosure, other and further embodiments of the disclosure may be devised without departing from the basic scope thereof, and the scope thereof is determined by the claims that follow.

What is claimed is:

1. A method for controlling access by an operating system to a device connected with a computer system based on a policy, the method comprising:
mapping a dummy driver to the device;
receiving, by the dummy driver, a request by the operating system to access services provided by the device;
determining, based on the policy, whether to block access to the device; and
upon determining to block access to the device, preventing services from being accessed via the operating system.

2. The method of claim 1, further comprising:
upon determining to allow access to the device, providing services to the device via a system framework provided by the operating system.

3. The method of claim 1, wherein mapping the dummy driver comprises:
identifying a first one or more drivers, from a plurality of drivers, having a provider class that matches the device, wherein the first one or more drivers includes the dummy driver;
identifying, from the first one or more drivers, a second one or more drivers having one or more properties that matches the device, wherein the second one or more drivers includes the dummy driver; and
generating, in each of the second one or more drivers, a probe score indicting a confidence of how suitable the driver is to the device, wherein the dummy driver generates a probe score that is higher than each of the plurality of drivers; and
mapping one of the second one or more drivers having a highest score to the device.

4. The method of claim 3, wherein the dummy driver is one of a plurality of drivers in a library maintained by the operating system.

5. The method of claim 4, wherein the operating system ranks each of the plurality of drivers based on a probe score generated by each of the plurality drivers.

6. The method of claim 1, wherein preventing services from being accessed to the device via the operating system comprises:
returning null to the operating system in response to the request.

7. The method of claim 1, wherein the operating system is a BSD UNIX-based operating system.

8. A non-transitory computer-readable storage medium storing instructions, which, when executed on a processor, perform an operation for controlling access by an operating system to a device connected with a computer system based on a policy, the operation comprising:
mapping a dummy driver to the device;
receiving, by the dummy driver, a request by the operating system to access services provided by the device;
determining, based on the policy, whether to block access to the device; and
upon determining to block access to the device, preventing services from being accessed via the operating system.

9. The computer-readable storage medium of claim 8, wherein the operation further comprises:
upon determining to allow access to the device, providing services to the device via a system framework provided by the operating system.

10. The computer-readable storage medium of claim 8, wherein mapping the dummy driver comprises:
identifying a first one or more drivers, from a plurality of drivers, having a provider class that matches the device, wherein the first one or more drivers includes the dummy driver;
identifying, from the first one or more drivers, a second one or more drivers having one or more properties that matches the device, wherein the second one or more drivers includes the dummy driver; and
generating, in each of the second one or more drivers, a probe score indicting a confidence of how suitable the driver is to the device, wherein the dummy driver generates a probe score that is higher than each of the plurality of drivers; and
mapping one of the second one or more drivers having a highest score to the device.

11. The computer-readable storage medium of claim 10, wherein the dummy driver is one of a plurality of drivers in a library maintained by the operating system.

12. The computer-readable storage medium of claim 11, wherein the operating system ranks each of the plurality of drivers based on a probe score generated by each of the plurality drivers.

13. The computer-readable storage medium of claim 8, wherein preventing services from being accessed to the device via the operating system comprises:
returning null to the operating system in response to the request.

14. The computer-readable storage medium of claim 8, wherein the operating system is a BSD UNIX-based operating system.

15. A system, comprising:
a processor; and
a memory storing program code, which, when executed on the processor, performs an operation controlling access by an operating system to a device connected with a computer system based on a policy, the operation comprising:
mapping a dummy driver to the device;
receiving, by the dummy driver, a request by the operating system to access services provided by the device;
determining, based on the policy, whether to block access to the device; and
upon determining to block access to the device, preventing services from being accessed via the operating system.

16. The system of claim 15, wherein the operation further comprises:
upon determining to allow access to the device, providing services to the device via a system framework provided by the operating system.

17. The system of claim 15, wherein mapping the dummy driver comprises:
identifying a first one or more drivers, from a plurality of drivers, having a provider class that matches the device, wherein the first one or more drivers includes the dummy driver;
identifying, from the first one or more drivers, a second one or more drivers having one or more properties that matches the device, wherein the second one or more drivers includes the dummy driver; and
generating, in each of the second one or more drivers, a probe score indicting a confidence of how suitable the driver is to the device, wherein the dummy driver generates a probe score that is higher than each of the plurality of drivers; and
mapping one of the second one or more drivers having a highest score to the device.

18. The system of claim 17, wherein the dummy driver is one of a plurality of drivers in a library maintained by the operating system.

19. The system of claim 18, wherein the operating system ranks each of the plurality of drivers based on a probe score generated by each of the plurality drivers.

20. The system of claim 15, wherein preventing services from being accessed to the device via the operating system comprises:
returning null to the operating system in response to the request.
